(19) United States
(12) Patent Application Publication
(10) Pub. No.: US 2006/0110115 A1
(43) Pub. Date: May 25, 2006

(54) Polycarbonate resin light diffusion plate

(75) Inventors: Toyohiro Hamamatsu, Niihama-shi (JP); Tomohiro Maekawa, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/230,674

(22) Filed: Sep. 21, 2005

(30) Foreign Application Priority Data
Sep. 30, 2004 (JP) 2004-286815

(51) Int. Cl. G02B 6/10

(52) U.S. Cl. 385/129

(57) ABSTRACT

A polycarbonate resin light diffusion plate capable to sufficiently diffusing light from plural light sources disposed direct thereunder, and having no or little luminance unevenness caused by the light sources, is provided. The light diffusion plate has characteristics such as a total light transmittance from 40-80%, a total light reflectance (Rt) 20-55%, and a diffusivity of 20% or more.

### BACKGROUND OF THE INVENTION

1. Field of the Invention

The invention relates to a polycarbonate resin light diffusion plate.

2. Description of the Background Art

As to a backlight (2) disposed on the rear surface side of a flat panel display (5) such as a liquid crystal display, there has been known a backlight provided with a light diffusion plate (1) for diffusing light from light sources (3) directing to an image device (4) uniformly and, for example, there has been also known, as shown in FIG. 1, a direct under type backlight (2) having plural light sources (3) installed direct under the light diffusion plate (1). In the case of the direct under backlight (2), a reflecting plate (6) is usually provided on the rear surface side of the light sources (3). As to the light diffusion plate (1), there has been known a light diffusion plate made of a polycarbonate resin in which a light diffusing agent is dispersed.

Since the direct under type backlight (2) has the light sources (3) direct under the light diffusion plate (1), a distance from the light sources (3) to the light diffusion plate (1) is small and a path length of light in the light diffusion plate (1) is also small. Hence, a light diffusion plate (1) capable of sufficiently diffusing light from the each light source (3) is required so as to have no luminance unevenness caused by the plural light sources (3).

A conventional light diffusing plate (1), however, has not been able to be said that the plate can sufficiently diffuse light from the light sources (3).

### SUMMARY OF THE INVENTION

The inventor has conducted serious studies in order to develop a light diffusion plate (1) made of a polycarbonate resin, capable to sufficiently diffusing light from plural light sources (3) disposed direct thereunder, and having no or little luminance unevenness caused by the light sources (3), which has led to the present invention.

That is, the invention provides a polycarbonate resin light diffusion plate (1) having:

a total light transmittance (Tt) in the range of from 40% to 80%;

a total light reflectance (Rt) in the range of from 20 to 55%;

a diffusivity (D) of 20% or more, which is obtained by the following formula (1):

$$D = \frac{I20 + I70}{2 \times I5} \times 100 ( \% ) \qquad ( 1 )$$

wherein I5 is an intensity of transmitted light (L₅) propagating at an angle of 5 degrees relative to the normal direction (a) thereof, I20 is an intensity of transmitted light (L₂₀) propagating at an angle of 20 degrees relative to the normal direction (a), and I70 is an intensity of transmitted light (L₇₀) propagating at an angle of 70 degrees relative to the normal direction (a), the transmitted lights (L₅, L₂₀ and L₇₀) being in transmitted light (L₀) measured when incident light (Lᵢ) passes from the normal direction (a); and

a light transmittance (T₄₃₅) at a wavelength of 435 nm, a light transmittance (T₅₄₅) at a wavelength of 545 nm and a light transmittance (T₆₁₀) at a wavelength of 610 nm, each light transmittance satisfying the following formulas (2), (3) and (4):

$$\begin{matrix}\frac{\vert {T}_{435} - {T}_{545} \vert}{{T}_{435}} \times 100 \leq 5 & ( 2 ) \\ \frac{\vert {T}_{545} - {T}_{610} \vert}{{T}_{545}} \times 100 \leq 8 & ( 3 ) \\ \frac{\vert {T}_{435} - {T}_{610} \vert}{{T}_{435}} \times 100 \leq 8. & ( 4 )\end{matrix}$$

Since, by a light diffusion plate (1) of the present invention, light from the light sources (3) can be sufficiently diffused, the direct under type backlight (2) having the light diffusing plate (1) therein gives a display image with no or little luminance unevenness.

### BRIEF DESCRIPTION OF THE DRAWINGS

FIG. 1 is a sectional view showing, as a model, an example of a flat panel display using a direct under type backlight; and

FIG. 2 is a model diagram showing a relationship between incident light impinging on a light diffusion plate and transmitted light propagating therefrom.

### DESCRIPTION OF THE PREFERRED EMBODIMENTS

A light diffusion plate (1) of the present invention is made of a polycarbonate resin. A polycarbonate resin used in the present invention can be produced in the methods which are described in “PLASTIC READER”, the 14^{th} revised version, published on May 10, 1985 by Plastic Age Co., pp. 152 to 153. For example, the polycarbonate resin can be produced by a method such as a phosgene method (a solution method) in which bisphenol A and phosgene are reacted with each other or an ester exchange method (a melting method) in which bisphenol A and diphenylcarbonate are reacted with each other. In the production, a catalyst, an end terminating agent, an antioxidant and others may be used. The polycarbonate resin may be a branched polycarbonated resin obtained by copolymerising a polyfunctional aromatic compound, which is tri- or more functional monomer, or may be a polyester carbonate resin obtained by copolymerising an aromatic or aliphatic bifunctional carboxylic acid. The light diffusion plate may be made of two or more kinds of polycarbonate resins combined.

A light diffusion plate (1) for a direct under backlight of the present invention has a total light transmittance (Tt) in the range of from 40 to 80% and preferably in the range of from 45 to 75%. If a total light transmittance is less than 40%, illumination with sufficient intensity is difficult, while if a total light transmittance is more than 80%, an image of the light sources tends to be viewed with ease and illuminance unevenness may be easy to occur. The total light transmittance can be measured according to JIS K-7361.

A light diffusion plate (1) of the present invention has a total light reflectance (Rt) in the range of from 20 to 55%. If a total light reflectance is less than 20%, an image of the light sources tends to be viewed with ease and luminance unevenness may be easy to occur. If a total light reflectance is more than 55%, light repeats reflection in the direct under type backlight (3) and is thereby attenuated; therefore, the image display device (4) is difficult to be illuminated with a sufficient intensity. The total light reflectance can be measured according to JIS K-7105.

A light diffusion plate (1) of the present invention has a diffusivity (D) of 20% or more, which is obtained by the following formula (1):

$$D = \frac{I20 + I70}{2 \times I5} \times 100 ( \% ) \qquad ( 1 )$$

wherein I5 is an intensity of transmitted light (L₅) propagating at an angle of 5 degrees relative to the normal direction (a) thereof, I20 is an intensity of transmitted light (L₂₀) propagating at an angle of 20 degrees relative to the normal direction (a), and I70 is an intensity of transmitted light (L₇₀) propagating at an angle of 70 degrees relative to the normal direction (a), the transmitted lights (L₅, L₂₀ and L₇₀) being in transmitted light (L₀) measured when incident light (Lᵢ) passes from the normal direction (a).

If a diffusivity (D) is less than 20%, luminance unevenness may be easy to occur. The diffusivity (D) may be 95% or less.

The light diffusion plate (1) of the present invention has a light transmittance (T₄₃₅) at a wavelength of 435 nm, a light transmittance (T₅₄₅) at a wavelength of 545 nm and a light transmittance (T₆₁₀) at a wavelength of 610 nm, each light transmittance satisfying the following formulas (2), (3) and (4):

$$\begin{matrix}\frac{\vert {T}_{435} - {T}_{545} \vert}{{T}_{435}} \times 100 \leq 5 & ( 2 ) \\ \frac{\vert {T}_{545} - {T}_{610} \vert}{{T}_{545}} \times 100 \leq 8 & ( 3 ) \\ \frac{\vert {T}_{435} - {T}_{610} \vert}{{T}_{435}} \times 100 \leq 8. & ( 4 )\end{matrix}$$

The light transmittance (T₄₃₅) at a wavelength of 435 nm, the light transmittance (T₅₄₅) at a wavelength of 545 nm and the light transmittance (T₆₁₀) at a wavelength of 610 nm can be measured according to “A method of measurement for a transmitting object” stipulated in JIS Z-8722, “A method of measurement for a color of an object”. The light transmittances are preferably equal to each other.

A light diffusion plate (1) of the present invention can be produced by a method of molding a polycarbonate resin composition comprising a polycarbonate resin and a light diffusing agent dispersed therein.

The light diffusing agent may be particles different in refractive index from a polycarbonate resin by an absolute value usually in the range of from 0.02 to 0.20. Examples of the light diffusing agent include inorganic particles such as calcium carbonate particles; barium sulfate particles; titanium oxide particles; aluminum hydroxide particles; silica particles; glass particles; talc particles; mica particles; white carbon particles; magnesium oxide particles; and zinc oxide particles. The inorganic particles may be surface treated with a surface treating agent such as an aliphatic acid. Other examples of the light diffusing agent include organic particles such as styrene-based polymer particles; acrylic-based polymer particles; and siloxane-based polymer particles. The light diffusing agents can be used alone or in combination of two or more of them.

In the case where siloxane-based polymer particles are used, silicone particles are preferably used because of being less in yellowing. The silicone particles may be particles having elasticity and being not cracked or broken down even under a load of 30 N/mm² of sectional area thereof.

The weight average particle diameter of a light diffusing agent may be in the range of 0.1 μm to 10 μm and preferably in the range of 1 μm to 10 μm.

The amount of a light diffusing agent to be used may be in the range of 0.01 part by weight to 20 parts by weight and preferably in the range of 0.05 part by weight to 10 parts by weight, relative to 100 parts by weight of a polycarbonate resin.

In the present invention, the particle different in refractive index from a polycarbonate resin is preferably adopted as a light diffusing agent and dispersed in the polycarbonate resin to thereby obtain a light diffusion plate in which light can be diffused by a so-called internal diffusion.

A light diffusion plate (1) of the present invention may have depressions and protrusions on a surface thereof to thereby diffuse light by the effect of the depressions and protrusions, that is a so-called external diffusion. Examples of methods for providing depressions and protrusions on a surface of a polycarbonate resin plate include a method of coating the plate with a coating liquid containing a light diffusing agent to form a surface layer containing the light diffusing agent, thereby providing depressions and protrusions thereon; a method of forming a resin layer containing a light diffusing agent on a surface of a polycarbonate resin plate to thereby provide depressions and protrusions thereon; a method of providing a polycarbonate resin plate with depressions and protrusions by roll transfer; a method of providing a polycarbonate resin plate with depressions and protrusions by cell transfer.

A light diffusion plate (1) of the present invention may contain well known additives such as a light stabilizer, an ultraviolet absorbent, a fluorescent whitening agent, an antioxidant, a mold releasing agent, a flame retardant and an antistatic agent.

A light diffusion plate (1) of the present invention may is be produced in a way such that a polycarbonate resin, a light diffusing agent and an additive are mechanically mixed with a mixer such as a Henshell mixer or a tumbler, thereafter the resulting mixture is melt kneaded with an extruder such as a monoaxial extruder or a biaxial extruder and/or one of various kinds of kneaders to prepare a polycarbonate resin composition, which is then molded into a sheet by means of an ordinary molding method such as an extrusion molding method, an injection molding method and/or a press molding method. Specifically, when an extrusion molding is conducted in the production, the light diffusion plate (1) can be prepared in the method such that a polycarbonate resin composition is melt kneaded with a monoaxial extruder or a biaxial extruder, thereafter the melt kneaded composition is extruded through a T die or a roll unit. In the extrusion molding, two or more extruders may be used to extrude the composition and another material through a feed block die, a multimanifold die or the like to thereby form a light diffusion plate with a multilayer structure of the present invention. Alternatively, two or more sheets obtained after the extrusion molding may be superimposed one on another, followed by the pressing thereon, to obtain a light diffusion plate of the present invention.

A thickness of a light diffusion plate (1) of the present invention may be in the range of from 0.2 to 5 mm.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2004-286815 filed on Sep. 30, 2004, both including specification, claims drawings and summary, are incorporated herein by reference in their entirety.

### EXAMPLES

The present invention is described in more detail by following Examples, which should not be construed as a limitation upon the scope of the present invention.

Note that evaluation methods are as follows:

(1) Total Light Transmittance (Tt)

A total light transmittance (Tt) was measured with a Poic integrating sphere Haze meter (with a trade name of SEP-HS-300, manufactured by Nihonseimitukougaku) according to JIS K-7361.

(2) Total Light Reflectance (Rt)

A total light reflectance (Rt) was measured with a Haze/transmittance meter (with a trade name of HR-100, manufactured by Murakami Color Research Laboratory Co.) according to JIS K-7105.

(3) Diffusivity (D)

As shown in FIG. 2, light (Lᵢ) was allowed to pass through a plate to be evaluated from the normal direction (a), to obtain transmitted light (L₀), which is a total transmitted light obtained after the passing through the plate.
Using an automatic variable angle photometer (with a trade name of GP-1R, manufactured by Murakami Color Research Laboratory Co.), of the transmitted light (L₀), an intensity (I5) of transmitted light (L₅) propagating at an angle of 5 degrees relative to the normal direction (a) thereof, an intensity (I20) transmitted light (L₂₀) propagating at an angle of 20 degrees relative to the normal direction (a) and an intensity (I70) transmitted light (L₇₀) propagating at an angle of 70 degrees relative to the normal direction (a) were measured. Based on the measured intensities, the diffusivity (D) of the plate was calculated using formula (1) below:

$$D = \frac{I20 + I70}{2 \times I5} \times 100 ( \% ) . \qquad ( 1 )$$

(4) Tone (T₄₃₅, T₅₄₅ and T₆₁₀)

Light transmittances (T) were measured at each wavelength increased by 1 nm at a time in the wavelength range of from 300 nm to 800 nm with a spectrophotometer (with a trade name of U4000, manufactured by Hitach, Ltd.) to thereby obtain a light transmittance (T₄₃₅) at a wavelength of 435 nm, a light transmittance (T₅₄₅) at a wavelength of 545 nm and a light transmittance (T₆₁₀) at a wavelength of 610 nm.

(5) Yellowing Degree (YI)

An yellowing degree (YI) was obtained by calculating XYZ values according to a method stipulated in JIS Z-8722 using the light transmittances (T) in the wavelength range of 300 nm to 800 nm measured in the above evaluation and then handling the values according to JIS K-7105.

(6) Average Luminance and Luminance Unevenness

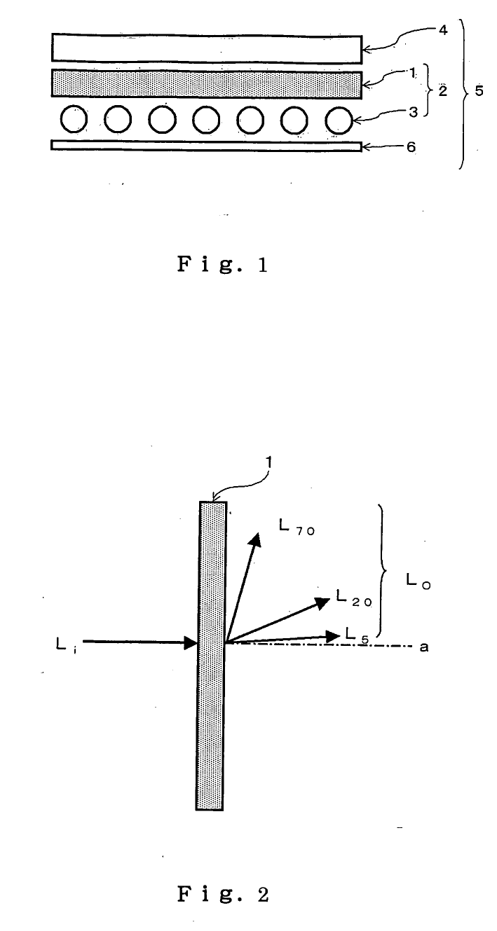

Nine 3 mmf cold cathode tubes (3) as light sources were, as shown in FIG. 1, arranged with a spacing of 3 cmoverareflecting sheet (6), and a light diffusion plate (1) was placed 14 mm thereabove, in parallel to the reflecting sheet (6). The cold cathode tubes (3) were lit up, and the resulting luminances were measured 90 cm above the light diffusion plate (1) (where an image device (4) is shown in FIG. 1) with a multipoint luminance meter (manufactured by Canon Inc.) not only to obtain the average value at 15 points in the range over middle 3 cold cathode tubes among the 9 cathode tubes (3), but also to obtain a ratio of the maximum value to the minimum value (maximum value/minimum value) of the 15 point luminances as luminance unevenness.

### Reference Example 1

Mixed together were 100 parts by weight of polycabonate resin pellets (with a trade name of SD1080, manufactured by Sumitomo Dow K.K. having a refractive index of 1.585) and 2 parts by weight of siloxane-based polymer particles (with a trade name of DY33-719, manufactured by Toray Dow Corning Silicone K.K. having a weight average particle diameter of 2 μm, Tg of −118° C. and a refractive index of 1.419) and thereafter, the resulting mixture was extruded into a sheet with an extruder in the condition of a resin temperature at a die outlet of 230° C. to thereby obtain polycabonate resin sheets, each having a thickness of about 0.5 mm and a width of about 3 cm.

Separately, siloxane-based polymer particles (DY33-719) used above were evaluated as follows:

A load was imposed on one particle of the siloxane-based polymer particles (DY33-719) by a pressing tool of 50 μm in diameter using a micro compression testing machine (with a trade name of MCTM/MCTE series, manufactured by Shimadzu Corp.), while the load is increased at a rate of 0.142 mN/sec. It was visually determined whether or not cracking and breaking-down of the particle occurred when the particle was compressed till the load per a unit sectional area of the particle reached 30 N/mm². As a result, the particle was neither cracked nor broken down.

### Comparative Example 1

Four sheets obtained in Reference Example 1 were superimposed one on another and were heat pressed by a heat press molding machine to obtain a light diffusion plate with a thickness of 2 mm. Evaluation results of the light diffusion plate are shown in Table 1 and Table 2.

### Example 1

Two sheets obtained in the same manner as in Reference Example 1 were superimposed one on the other and were heat pressed to obtain a light diffusion plate with a thickness of 1 mm. Evaluation results of the light diffusion plate are shown in Table 1 and Table 2.

### Example 2

Two sheets obtained in the same manner as in Reference Example 1 were superimposed one on the other and were heat pressed to obtain a light diffusion plate with a thickness of 0.7 mm. Evaluation results of the light diffusion plate are shown in Table 1 and Table 2.

### Example 3

A single sheet obtained in the same manner as in Reference Example 1 was heat pressed to obtain a light diffusion plate with a thickness of 0.3 mm. Evaluation results of the light diffusion plate are shown in Table 1 and Table 2.

### Reference Example 2

Polycabonate resin sheets, each having a thickness of about 0.5 mm and a width of about 3 cm, were obtained in the same manner as in Reference Example 1, except that 2 parts by weight of siloxane-based polymer particles (with a trade name of TOSPEARL 145, manufactured by Toshiba Silicone Co., Ltd. having a weight average particle diameter of 4.5 μm and a refractive index of 1.430) was used instead of using siloxane-based polymer particles DY33-719. Evaluation results are shown in Table 1 and Table 2.

Separately, the siloxane-based polymer particles (TOSPEARL 145) were evaluated in the same manner as in Reference Example 1. Namely, one siloxane-based polymer particle (TOSPEARL 145) was compressed till a load per a unit sectional area of the particle reached 30 N/mm² and was visually determined whether or not cracking and breaking-down of the particle occurred. As a result, the particle had been cracked.

### Comparative Example 2

Four sheets obtained in Reference Example 2 were superimposed one on another and were heat pressed by a heat press molding machine to obtain a light diffusion plate with a thickness of 2 mm. Evaluation results of the light diffusion plate are shown in Table 1 and Table 2.

### Example 4

Two sheets obtained in the same manner as in Reference Example 2 were superimposed one on the other and were heat pressed to obtain a light diffusion plate with a thickness of 1 mm. Evaluation results of the light diffusion plate are shown in Table 1 and Table 2.

### Example 5

Two sheets obtained in the same manner as in Reference Example 2 were superimposed one on the other and were heat pressed to obtain a light diffusion plate with a thickness of 0.7 mm. Evaluation results of the light diffusion plate are shown in Table 1 and Table 2.

### Example 6

A single sheet obtained in the same manner as in Reference Example 2 was heat pressed to obtain a light diffusion plate with a thickness of 0.3 mm. Evaluation results of the light diffusion plate are shown in Table 1 and Table 2.

### Reference Example 3

Polycabonate resin sheets, each having a thickness of about 0.5 mm and a width of about 3 cm, were obtained in the same manner as in Reference Example 1, except that 2 parts by weight of methyl methacrylate-based polymer particles (having a weight average particle diameter of 3 μm and a refractive index of 1.49) instead of using siloxane-based polymer particles DY33-719. Evaluation results of the light diffusion plate are shown in Table 1 and Table 2.

### Comparative Example 3

Four sheets obtained in Reference Example 3 were superimposed one on another and were heat pressed by a heat press molding machine to obtain a light diffusion plate with a thickness of 2 mm. Evaluation results of the light diffusion plate are shown in Table 1 and Table 2.

### Comparative Example 4

Two sheets obtained in the same manner as in Reference Example 3 were superimposed one on the other and were heat pressed to obtain a light diffusion plate with a thickness of 1 mm. Evaluation results of the light diffusion plate are shown in Table 1 and Table 2.

### Comparative Example 5

Two sheets obtained in the same manner as in Reference Example 3 were superimposed one on the other and were heat pressed to obtain a light diffusion plate with a thickness of 0.7 mm. Evaluation results of the light diffusion plate are shown in Table 1 and Table 2.

### Comparative Example 6

A single sheet obtained in the same manner as in Reference Example 3 was heat pressed to obtain a light diffusion plate with a thickness of 0.3 mm. Evaluation results of the light diffusion plate are shown in Table 1 and Table 2.

TABLE 1

| | | | | | Light transmittance (T) | | | | Average | Luminance |
|---|---|---|---|---|---|---|---|---|---|---|
| | Thickness | Tt | Rt | D | 435 nm | 545 nm | 610 nm | | luminance | unevenness |
| | (mm) | (%) | (%) | (%) | (%) | (%) | (%) | YI | (cd/m²) | (cd/m²) |
| Comparative | 2.0 | 37 | 59 | 95 | 32 | 33 | 34 | 5.4 | 3323 | 1.20 |
| Example 1 | | | | | | | | | | |
| Example 1 | 1.0 | 45 | 51 | 91 | 45 | 46 | 47 | 3.0 | 3884 | 1.22 |
| Example 2 | 0.7 | 51 | 46 | 93 | 51 | 52 | 52 | 2.0 | 4242 | 1.15 |
| Example 3 | 0.3 | 64 | 38 | 77 | 62 | 63 | 64 | 2.3 | 4783 | 1.25 |
| Comparative | 2.0 | 45 | 41 | 95 | 37 | 41 | 42 | 8.5 | 3682 | 1.15 |
| Example 2 | | | | | | | | | | |
| Example 4 | 1.0 | 56 | 38 | 90 | 51 | 53 | 54 | 4.3 | 4251 | 1.20 |
| Example 5 | 0.7 | 62 | 36 | 80 | 59 | 61 | 62 | 3.6 | 4676 | 1.22 |
| Example 6 | 0.3 | 75 | 30 | 53 | 74 | 75 | 77 | 3.0 | 5427 | 1.78 |
| Comparative | 2.0 | 61 | 24 | 68 | 55 | 59 | 62 | 9.3 | 4966 | 1.32 |
| Example 3 | | | | | | | | | | |
| Comparative | 1.0 | 78 | 23 | 50 | 74 | 78 | 80 | 6.2 | 5540 | 1.64 |
| Example 4 | | | | | | | | | | |
| Comparative | 0.7 | 83 | 22 | 37 | 83 | 86 | 87 | 3.3 | 5813 | 1.93 |
| Example 5 | | | | | | | | | | |
| Comparative | 0.3 | 88 | 18 | 18 | 92 | 91 | 91 | −0.9 | 5967 | 2.74 |
| Example 6 | | | | | | | | | | |

TABLE 2

| | Calculated values | | |
|---|---|---|---|
| | $\frac{\vert {T}_{435} - {T}_{545} \vert}{{T}_{435}} \times 100 ( \% )$ | $\frac{\vert {T}_{545} - {T}_{610} \vert}{{T}_{545}} \times 100 ( \% )$ | $\frac{\vert {T}_{435} - {T}_{610} \vert}{{T}_{435}} \times 100 ( \% )$ |
| Comparative Example 1 | 3 | 3 | 6 |
| Example 1 | 2 | 2 | 4 |
| Example 2 | 2 | 0 | 2 |
| Example 3 | 2 | 2 | 3 |
| Comparative Example 2 | 11 | 2 | 14 |
| Example 4 | 4 | 2 | 6 |
| Example 5 | 2 | 2 | 5 |
| Example 6 | 1 | 3 | 4 |
| Comparative Example 3 | 7 | 5 | 13 |
| Comparative Example 4 | 5 | 3 | 8 |
| Comparative Example 5 | 3 | 1 | 5 |
| Comparative Example 6 | 1 | 0 | 1 |

What is claimed is:

1. A polycarbonate resin light diffusion plate (1) having:
a total light transmittance (Tt) in the range of from 40% to 80%;
a total light reflectance (Rt) in the range of from 20 to 55%;
a diffusivity (D) of 20% or more, which is obtained by the following formula (1):
$$D = \frac{I20 + I70}{2 \times I5} \times 100 ( \% ) \qquad ( 1 )$$
wherein I5 is an intensity of transmitted light (L₅) propagating at an angle of 5 degrees relative to the normal direction (a) thereof, I20 is an intensity of transmitted light (L₂₀) propagating at an angle of 20 degrees relative to the normal direction (a), and I70 is an intensity of transmitted light (L₇₀) propagating at an angle of 70 degrees relative to the normal direction (a), the transmitted lights (L₅, L₂₀ and L₇₀) being in transmitted light (L₀) measured when incident light (Lᵢ) passes from the normal direction (a); and
a light transmittance (T₄₃₅) at a wavelength of 435 nm, a light transmittance (T₅₄₅) at a wavelength of 545 nm and a light transmittance (T₆₁₀) at a wavelength of 610 nm, each light transmittance satisfying the following formulas (2), (3) and (4):
$$\begin{matrix}\frac{\vert {T}_{435} - {T}_{545} \vert}{{T}_{435}} \times 100 \leq 5 & ( 2 ) \\ \frac{\vert {T}_{545} - {T}_{610} \vert}{{T}_{545}} \times 100 \leq 8 & ( 3 ) \\ \frac{\vert {T}_{435} - {T}_{610} \vert}{{T}_{435}} \times 100 \leq 8. & ( 4 )\end{matrix}$$

2. A method for producing a polycarbonate resin light diffusion plate, the method comprising the steps of:
mixing a composition comprising a polycarbonate resin and a light diffusing agent;
extruding the resulting mixture through a die to obtain a polycarbonate resin light diffusion plate having:
a total light transmittance (Tt) in the range of from 40% to 80%;
a total light reflectance (Rt) in the range of from 20 to 55%;
a diffusivity (D) of 20% or more, which is obtained by formula (1); and
a light transmittance (T₄₃₅) at a wavelength of 435 nm, a light transmittance (T₅₄₅) at a wavelength of 545 nm and a light transmittance (T₆₁₀) at a wavelength of 610 nm, each light transmittance satisfying formulas (2), (3) and (4).
